(19) United States
(12) Patent Application Publication
(10) Pub. No.: US 2015/0199431 A1
(43) Pub. Date: Jul. 16, 2015

(54) System and Method of Search for Improving Relevance Based on Device Parameters

(71) Applicant: CrowdCare Corporation, Richmond Hill (CA)

(72) Inventors: Jeffrey Brunet, Aurora (CA); Yousuf Chowdhary, Maple (CA); Ian Collins, Markham (CA)

(21) Appl. No.: 14/595,271

(22) Filed: Jan. 13, 2015

Related U.S. Application Data
(60) Provisional application No. 61/964,860, filed on Jan. 16, 2014.

(51) Int. Cl. G06F 17/30; G06Q 30/00

(52) U.S. Cl. CPC G06F 17/30864; G06Q 30/016

(57) ABSTRACT

A method is provided for augmenting a search query. Terms of a basic search query are received with respect to a user's device. A device profile of the device is retrieved. An augmented search query is formed by concatenating device parameters of the device profile with at least one of the terms of the basic search query. This augmented search query is then submitted to a search engine, and the results are displayed. A method of enhancing a device self-care session through an augmented search is also provided.

### CROSS-REFERENCE TO RELATED APPLICATIONS

This application claims the benefit of U.S. Provisional Patent Application No. 61/964,860, filed Jan. 16, 2014 and entitled “System and Method of Search for Improving Relevance Based on Device Parameters,” which is incorporated herein by reference in its entirety.

### FIELD OF INVENTION

The invention in general relates to information searching in the context of customer care and self-care systems for electronic devices.

### BACKGROUND

The current method of gathering and obtaining device information required for diagnostics is manual and therefore complex, time-consuming and prone to human errors. This situation is only getting worse with the passage of time as devices become more powerful and capable of handling more sophisticated tasks. Customers no longer want to call service providers to get basic problems resolved. The result is increased support costs, increased call handling times, complex diagnostic processes and overall frustration.

One existing method to overcome the above issues is self-care including customer care apps and web based self-care systems, whereby information is provided to the users so the users can use the information to resolve some of the basic issues themselves, thus helping reduce some of the costs.

Although such systems deliver a more convenient, always-on, communication channel, they have serious shortcomings. Such methods lack automation and the user is required to sift through massive amounts of data manually to get to the relevant information. Another common issue is that each customer has to solve their own problem from the beginning.

A user is required to use a search engine to find the relevant information regarding their problem. A search engine is an information retrieval system that allows a user of a connected device e.g. a computer or a Smartphone to specify search criteria by inputting a search query for an item of interest. In the case of text search engine, e.g. Google, the search query is typically expressed as a set of words. The user is expected to type the search query into a text input area (e.g. a web page) and after submitting the search query, the search engine then displays the results of matching items that the search engine found about the item of interest.

However, such search methods have an emphasis on speeding up the search process and offering a multitude of results to the user, which may come at the cost of accuracy. Thus providing hundreds of results in sub seconds in not unusual, and it is not unusual that many of these search results may have a low relevance to the search query. The user is expected to sift through the search results that are typically displayed on the screen of the device. The user is expected to go to each of the links and read the content of each site, article, etc. until they find what they are looking for.

Additionally in order to get more relevant results from a search, a user is expected to add more details to the search query. This requires the user to first find this information before continuing the search. Once the user has found this information, the user must add this information to the search query by manual input e.g. typing on a touchscreen or a keyboard. This process is time consuming and error prone.

As an example, if a user is searching for information about a problem on a specific connected device e.g. a Smartphone or a tablet, the user is expected to first find out the device information and then type that device information accurately into the search input area of a search engine. Thus a user searching for how to “hard reset device” will need to find out the device make (e.g. Samsung), device model (Galaxy S4), OS version (e.g. 4.2.2) etc. before initiating a search as the instructions for hard resetting a device may vary greatly depending on the device make and model.

Alternatively, if a user simply does a generic search for “hard reset my device”, the results will include results for all kinds of devices (many of which are not relevant). The user may have to wade through the results to find relevant information, or may inadvertently follow instructions for the wrong device (e.g. following Android directions which are different from those for an iPhone).

Therefore we note that prior art methods have inherent limitations and are in need of improvement.

### SUMMARY

Broadly speaking, the present invention provides a method for searching that improves the relevance of the search results by first extracting information from a device and then injecting this information into a search query preferably without any user interaction.

The system provides an app that can be installed on a device. Using this app a user can initiate a search by entering a search query. The app gathers device profile information from the device, injects select parameters/terms/information from the device profile into the search query, submits the search query to one or more search engines, receives search results from one or more search engines and preferably filters the received search results and displays select results to a user. It is to be noted that the extraction of information from the device and the injection of terms/parameters into the search query and the filtering of the search results is preferably done without any aid from the user.

The system and method provides a meaningful benefit by providing a solution whereby the relevant parameters/terms/information are extracted from the device, and are used to aid in increasing the relevance of the search results. Parameters/terms/information that may be gathered from the device may include but are not limited to device make, model, OS and firmware version, language, location, operator, information extracted from error logs etc.

In one embodiment, the app receives search results from one or more search engines, then filters the search results using the device profile parameters/information before displaying select search results to the user.

In another embodiment, the app first extracts information from the device, injects the parameters from the device information into a search query, then filters search results received from one or more search engines before displaying select search results to the user.

The search may first review curated content like a forum, then if no results are found in the curated content, search the internet using the terms extracted from the device.

In addition to the user's search query, the app gathers device information and additionally the system may take into account such other matters as the question asked by the user, call history, previous problems etc. A rules engine may be used to analyze this information.

In some embodiments, the app may first parse the user query to identify terms from the query, and then gather select information regarding the identified terms from the device to inject select parameters into the search query.

Devices that can benefit from the system may include but are not limited to devices exemplified here, for example a Smartphone, a tablet, a game console, a computer e.g. a personal computer, a laptop, a tablet computer, a server; a network appliance, a set-top box, a SmartTV, an embedded device, a computer expansion module, a personal data assistant (PDA), game device, e-reader, any appliances having internet or wireless connectivity, onboard automotive devices such as navigational and entertainment systems and the like.

Thus we note that the system and method provides a meaningful benefit by providing a solution whereby the search results are more relevant to the search query by adding terms extracted from the device into the search query.

According to a first aspect of the invention, a method is provided for augmenting a search query. Terms of a basic search query are received with respect to a user's device. A device profile of the device is retrieved. The profile has device parameters. An augmented search query is formed by concatenating at least one of the device parameters with at least one of the terms of the basic search query (i.e. the device parameter(s) are “injected” into the query). The augmented search query is submitted to a search engine. At least one result of the augmented search query is displayed. “Concatenating” in this case is simply used to mean combining together to form an interpretable search query (and may include combinations in any order and with or without spacing, tags, operators, punctuation, etc.).

The terms of the basic search query may be received by typing text, or they may be received by voice input.

In one embodiment, the basic search query is received through a specialized app on the device.

The device profile may be freshly extracted at the time of the basic search query, or may be from a cache of a previous device profile (e.g. from a previous customer care or self care session, or from periodic device profiling done on a regular basis).

Forming the augmented search query may include parsing the terms of the basic search query. It may also include adding Boolean operators, wildcards, quotes, or parentheses. It may also include following a specified syntax of the search engine. Certain terms may be dropped from the basic search query. Terms may also be substituted for industry standard terminology. Terms in abbreviated form may also be replaced with full names.

The device parameter may be selected as one relevant to the at least one term of the basic search query.

In certain embodiments, the search may be submitted to a specialized website or forum, alternatively or in addition to searching the Internet more broadly.

The results may be filtered before displaying. For example, the relevance of the results may be assessed based on at least one device parameter. If the results are not sufficiently relevant (or if there are too many results), a new search may be submitted with more parameters. Alternatively, if there are too few results (or the results are too narrow or specific), a new search is submitted with fewer parameters.

A term from a previous query or problem may also be added.

The parameters to be used may be selected by the user, or they may be automatically selected.

The at least one result may be displayed on the device, or on a device connected to the device.

In certain embodiments, the entire method may be carried out on the device.

The basic search query may be entered by a user, or in certain embodiments, may be entered by a CSR (Customer Service Representative). Likewise, the results may be displayed on the user's device, on a CSR terminal, or both.

According to a second aspect of the invention, a method is provided for enhancing a device self-care session through an augmented search. A self-care session for a device is initiated with respect to a particular issue. A device profile of the device is retrieved, which has device parameters. (This may be retrieved “fresh” or from a cache.) An initial diagnostic step is performed, including submitting the issue and at least one of the device parameters to a rules engine. (For example, this diagnosis may have reference to a rules-based knowledgebase.) After the initial diagnostic step, an augmented search query is formed by concatenating at least one of the device parameters with at least one term describing the issue. The augmented search query is submitted to a search engine. At least one result of the augmented search query is then displayed.

The initial diagnostic step may involve obtaining a device profile, diagnosing a problem or a problem area on the device and using this problem, problem area, key words related to problem or problem area, any parameters that are inconsistent on the device etc. and using these in the augmented search in addition to the user entered search query along with other factors mentioned in this disclosure.

### BRIEF DESCRIPTION OF THE FIGURES

FIG. 1 is a flow diagram illustrating a basic search method according to an aspect

FIG. 2 is a flow diagram of filtering search results using device parameters and displaying the results selectively.

FIG. 3 is a flow diagram of searching with filtering.

FIG. 4 is a flow diagram of searching curated content using the method.

FIG. 5 is a flow diagram where the method is enhanced with additional information.

FIG. 6 is a flow diagram of searching with parsing of a user query.

### DETAILED DESCRIPTION

Before embodiments are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements. However, in at least one embodiment, the components comprised in the method and tool are actually implemented in software.

The present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or another simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a Smartphone, a tablet, server, network appliance, set-top box, SmartTV, embedded device, computer expansion module, personal computer, laptop, tablet computer, personal data assistant, game device, e-reader, etc. Other devices include appliances having internet or wireless connectivity and onboard automotive devices such as navigational and entertainment systems.

The program code may execute entirely on a device or partly on a device as a stand-alone software package; partly on a device and partly on a remote computer or entirely on the remote computer or server. In the latter scenario, the remote computer may be connected to the device through any type of network, including a local area network (LAN) or a wide area network (WAN), or the connection may be made to the internet through a mobile operator network (e.g. a cellular network). The code is specialized to execute functions described herein which enable a smoother and more efficient technological process.

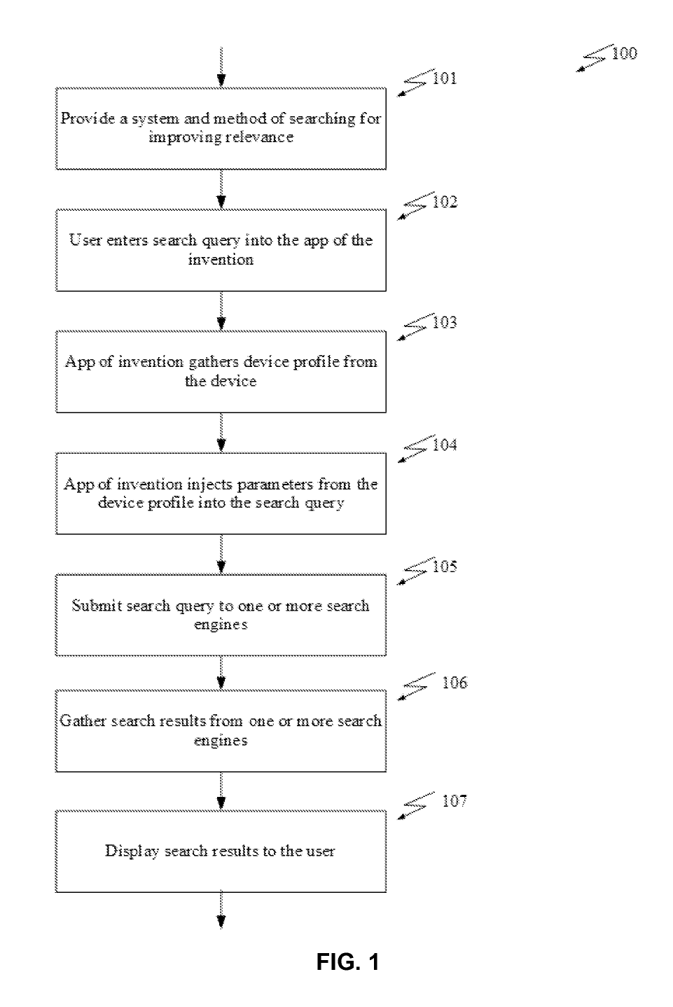

FIG. 1 shows one embodiment of the present method 100. A system and method of searching is provided 101 that can be used in a self-care system as well as customer-care systems. Allowing for improved search relevance, such a system reduces expense and increases the overall efficiency of the system, as it takes fewer customer care resources to support the customer base.

Increasingly customers do not want to call service providers to get basic problems resolved. Web based self-care systems are able to deliver a more convenient, always-on communication channel, that helps lower cost of customer service and reducing staff workload, by eliminating the number of customer service calls. Self-care systems enable customers to trouble shoot some of the basic issues that they may encounter.

A user enters a basic search query into an app 102. This may take the form of a typical text search which requires that a user type text into a search area provided by the user interface for initiating a search. For example the user may type “Bluetooth not working” into the search area.

The app can then gather a device profile from the device 103. One method of gathering device profiles is to have an app installed on the device that queries the device for its settings. One such app is described and taught in U.S. patent application Ser. No. 13/968,631, filed Aug. 16, 2013, which is incorporated herein by reference. Another related system using a device-based approach is described and taught in U.S. patent application Ser. No. 14/256,640, filed Apr. 18, 2014, which is incorporated herein by reference.

Information that can be gathered from the device may include but is not limited to: the device make, model and manufacture information; applications (commonly referred to as “apps”) installed on the device; apps and processing running on the device; certificates on the device; user profile information; the character of any passcode used to authenticate a user (e.g. whether a password/passcode is used and the relative strength of that password, such as the number of characters); operating system of the device; information regarding whether the device operating system has been tampered with by the user (e.g. an iOS device has been jailbroken, or a Google Android device has been rooted); and settings for SMTP servers, Gateway IP addresses, APN, Build Versions, list of malicious apps, etc.

In one embodiment the app may query the device and after gathering the device profile may preferably cache it so that this information can be used in the future as well.

In another embodiment the app may query the device and use this information in real time, thus each time a user starts a search query, a new set of information is extracted from the device to ensure that it accurately reflects the most current set of information.

The app can then inject parameters from the device profile into the search query 104. For example, the app may gather and inject device make, device model, OS version, language, operator and location:

Device Make=Samsung

Device Model=Galaxy S4

Operating System=Android 4.2.2

Language=English

Operator=AT&T

Location=Houston, Tex. USA

In one embodiment the device parameters information may be gathered from the device in real time. In an alternate embodiment the device parameter information may be gathered from information cached earlier.

All of the above terms may be added into the search query, or only select terms may be added. In one embodiment the parameters that may be inserted into the search query may be narrowed down based on the make or model of the device, its operating system, operating system version, firmware version, language, area of use, user preferences, etc.

Information may also be extracted and injected from the error logs for example types of errors, number of errors in an error log, severity of errors, number and frequency of crashes of the device etc.

There may be other sets of information that may be extracted from the device and injected into the search query. The intent is to cover all practical combinations and permutations.

The search query is then submitted to one or more search engines 105. A search engine is a software system that is designed to search for information on the Internet. Examples of popular search engines include Google, Yahoo, Bing, Baidu, etc. A search engine typically works by first storing information about a large number of web sites using an automated process called web crawler or spider. The web crawler then follows every link on the site, analyzing the contents of each web page to determine how it should be indexed. Data about web pages are stored in an index database for use in later queries. When a user enters a query into a search engine (typically by using keywords), the engine examines its index and provides a listing of best-matching web pages according to its criteria, usually with a short summary containing the document's title and sometimes parts of the text. The usefulness of a search engine depends on the relevance of the results that it returns in response to a search query.

Search results are gathered from one or more search engines 106. For example the app may receive search results from Google, Yahoo and Bing.

The search results are displayed to the user 107 for example using the display of the device. For example the search results may be displayed on a touchscreen of a Smartphone, or the display of a SmartTV etc. For devices that may not have their own native display e.g. a set top box, the search results may be displayed on a display connected to the said device; in this case a TV or a monitor. Alternatively, or in addition, the results may be displayed on a CSR (i.e. Customer Service Representative) terminal.

The app may have an agent that has the capability to connect to the internet, in addition to providing a user interface for entering search queries, querying the device for a device profile, and extracting the device parameters.

The app may use an advanced search functionality provided by a search engine. For example Google's search engine normally accepts queries as a simple text, and breaks up the user's text into a sequence of search terms, which will usually be words that are to occur in the results; but in advanced search it can also use Boolean operators (AND, OR, NOT) as well as quotations marks (“) for a phrase, a prefix such as “+”, “−” for qualified terms. Google Search provides several options for customized searches, using Boolean operators such as: exclusion (“−xx”), alternatives (“xx OR yy”), and wildcards (“x*x”). Google provides a well-documented guide to advanced searches and search operators that work with the Google search engine at:
http://www.googleguide.com/advanced_operators_reference.html

The following examples illustrate some operators used in advanced/customized searches:

In one embodiment quotes (“ ”) may be used to search for an exact word or set of words. This option is useful when searching for a set of words. For example:

“hard reset device”

A dash (-) may be used before a word or site to exclude all results that include that word. This is especially useful for synonyms like Jaguar the car brand and jaguar the animal. For example:

jaguar speed-car

### Or

samsung-HTC

The term ‘site’ may be for more results from a certain website in the search query. For example in order to search for all mentions of “GalaxyS4” on the Samsung website:

GalaxyS4 site:samsung.com

The operator OR (capitalized) may be used in order to search for pages that may have just one of several words. OR can be used between the words or sets of words, for example:

WiFi not working Samsung OR Galaxy S4

alternatively;

“WiFi not working Samsung” OR “WiFi not working Galaxy S4”

Similarly ‘˜’ can be used for searching synonyms; and ‘..’ can be used for searching a range e.g. 20..50.

The examples provided above are exemplary and are not intended to limit the invention. Similarly other search engines may also provide operators for customized searches. Any number and combination of search operators or other syntactical elements may be used in a search query. Alternatively, or in addition, the device data and operators may be injected into a search engine API.

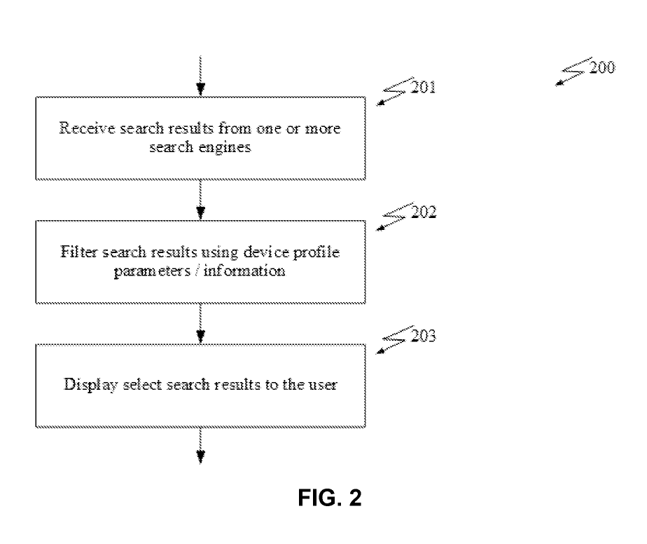

FIG. 2 shows one embodiment 200. Search results are received from one or more search engines 201. For example the app may receive search results from Google, Yahoo and Bing.

The search results are filtered using the device profile parameters/information 202. The parameters that may be used for filtering the received search results may include but are not limited to the make or model of the device, its operating system, operating system version, firmware version, language, geographical area of use, user preferences, etc.

The app can then filter the search results using the terms, device profile parameters/information that were initially inserted into the search query. In another embodiment the app may use terms other than the ones inserted into the search query to further refine the search results. Any search results that do not contain the relevant information and thus are low in relevance to the search query may be rejected while those that are highly relevant to the search query may be used further.

Select search results can then be displayed to the user 203. For example the select search results can be displayed using the user interface of the app on a touchscreen of a Smartphone, or the display of a SmartTV. For devices that may not have their own native display e.g. a set top box, the select search results may be displayed on a display that may be connected to the said device; in this case a TV or a monitor.

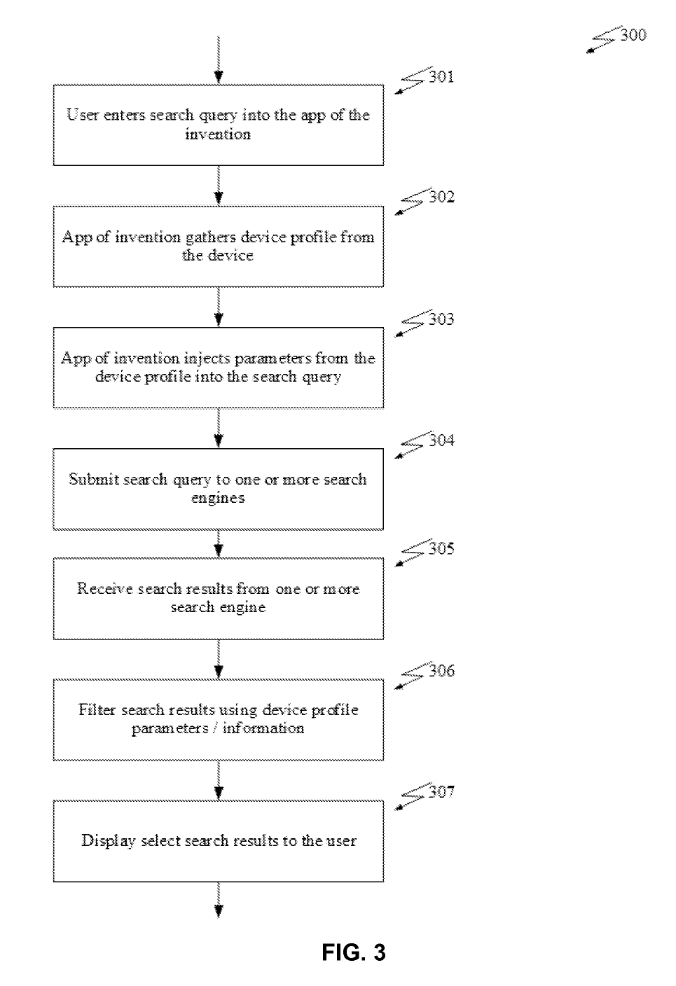

In another embodiment as shown in FIG. 3, the user enters a basic search query into the app 301 e.g. an app that is installed on the device. The app may provide a text search input, or a voice based search query whereby the user is able to initiate a search query using voice commands.

The app gathers a device profile from the device 302. Examples of the parameter settings in a device profile that may be extracted from a device may include, but are not limited to: the device model and manufacture information; applications (commonly referred to as “apps”) installed on the device; apps and processing running on the device; certificates on the device; user profile information; the character of any passcode used to authenticate a user (e.g. whether a password/passcode is used and the relative strength of that password, such as the number of characters); operating system of the device; information regarding whether the device operating system has been tampered with by the user (e.g. an iOS device has been jailbroken, or a Google Android device has been rooted); and it may embody the actual, required values for the different fields e.g. SMTP Server, Gateway IP addresses, APN, Build Versions, list of malicious apps, information extracted from the error logs etc.

The app injects parameters from the device profile into the search query 303. In one embodiment, this process of parameter extraction and insertion into the search query may be automatic. In another embodiment, the user may be provided with a list with check boxes that can be checked in order to select the parameters that may be injected into the search query. In another embodiment the app may cycle through each parameter and perform a search in a sequence until all parameters have been searched.

The search query can then be submitted to one or more search engines 304. For example the search query may be submitted to Google, Yahoo, Bing and any other search engine that may be considered relevant to the search and the location of the user.

Search results are received from one or more search engines 305. For example, the search results may be received from Google, Yahoo, Bing and any other search engine that may have been used.

The search results are filtered using device profile parameters/information 306. In one embodiment the parameters that may be used for filtering the received search results may include but are not limited to the make or model of the device, its operating system, operating system version, firmware version, language, geographical area of use, user preferences, etc.

In one embodiment the app filters search results using the terms, device profile parameters/information that were initially inserted into the search query. In another embodiment the app may use terms other than the ones inserted into the search query to further refine the search results. Any search results that do not contain the relevant information and thus are low in relevance to the search query are rejected while those that are highly relevant to the search query are to be used further.

The select search results may be displayed to the user 307. For example the search results may be displayed on a touchscreen of a Smartphone, or the display of a SmartTV etc. For devices that may not have their own native display e.g. a set top box, filtered search results may be displayed on a display connected to the said device; in this case a TV or a monitor.

For example the user may enter “hard reset device” for the basic search. The method and system then automatically adds the device make, model, OS and firmware version to the search query. Thus the query may preferably be changed to:

“hard reset device samsung galaxy S4”

Or alternatively the search query may even drop the term “device” as it has been qualified by adding the device make and model. Thus the exemplary query may be preferably changed to:

“hard reset samsung galaxy S4”

Yet another variation of the search query may preferably be used in order to only search the Samsung website, thus changing the search query to:

“hard reset samsung galaxy S4” site:samsung.com

One or more searches may be performed with a combination of several variations that are possible. The intent is to cover all practical variations and permutations.

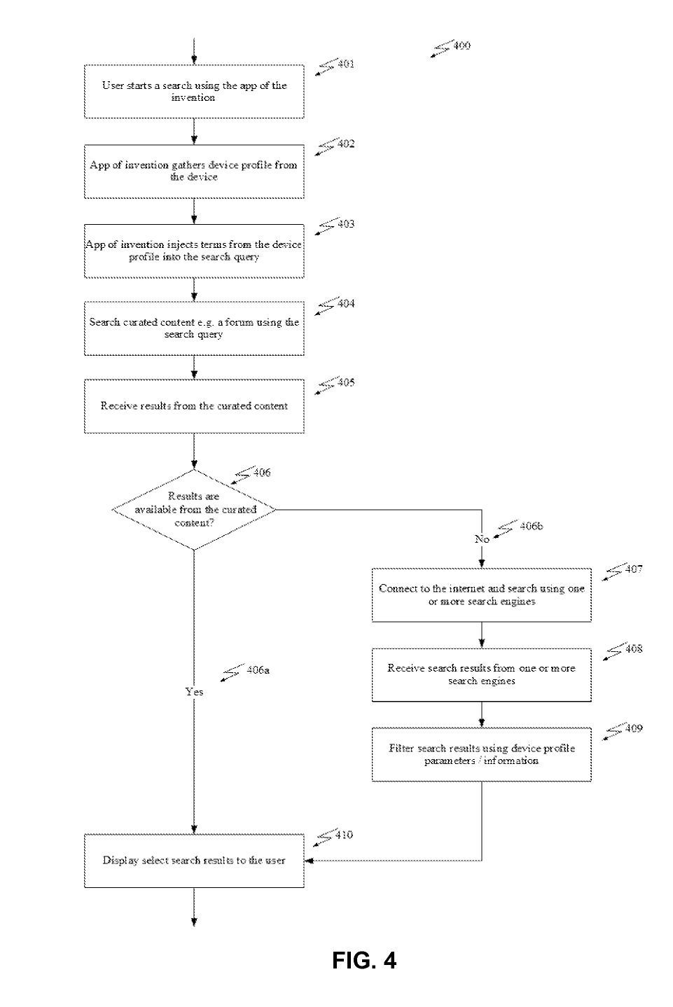

Turning to FIG. 4, the user starts a search using the app 401 installed on the device.

The app gathers device profile from the device 402. The app injects parameters/terms from the device profile into the search query 403.

Curated content e.g. a forum is searched using the search query 404. Curated content is content aggregated from various sources into one comprehensive resource (for example a blog post, a forum, an external knowledge base etc.). Curated content is a valuable way of amassing content from a variety of sources, and delivering it in an organized fashion and can take the form of an RSS feed, links posted on blogs, social media feeds, or an online news mashup. In general quality and relevance are high in curated content as the content has been purposefully gathered in one central location for a given reason.

Results are received from the curated content search 405 and checked for relevance 406. If relevant search results are available from the curated content 406a, then select search results are displayed to the user 410.

If no relevant search results are available from the curated content 406b, then the app connects to the internet and searches using one or more search engines 407.

Search results are received from one or more search engines 408. In one embodiment the app receives search results from Google, Yahoo, Bing and any other search engine that may have been used.

The search results are filtered using device profile parameters/information 409. In one embodiment the app filters search results using the terms, device profile parameters/information that was initially inserted into the search query. In another embodiment when filtering the search results the app may use terms other than the ones inserted into the search query to further refine the search results. Any search results that do not contain the relevant information and thus are low in relevance to the search query are rejected while those that are highly relevant to the search query are to be used further.

Select search results are displayed to the user 410. For example the search results may be displayed on a touchscreen of a Smartphone, or the display of a SmartTV etc. For devices that may not have their own native display e.g. a set top box, filtered search results may be displayed on a display that may be connected to the said device; in this case a TV or a monitor.

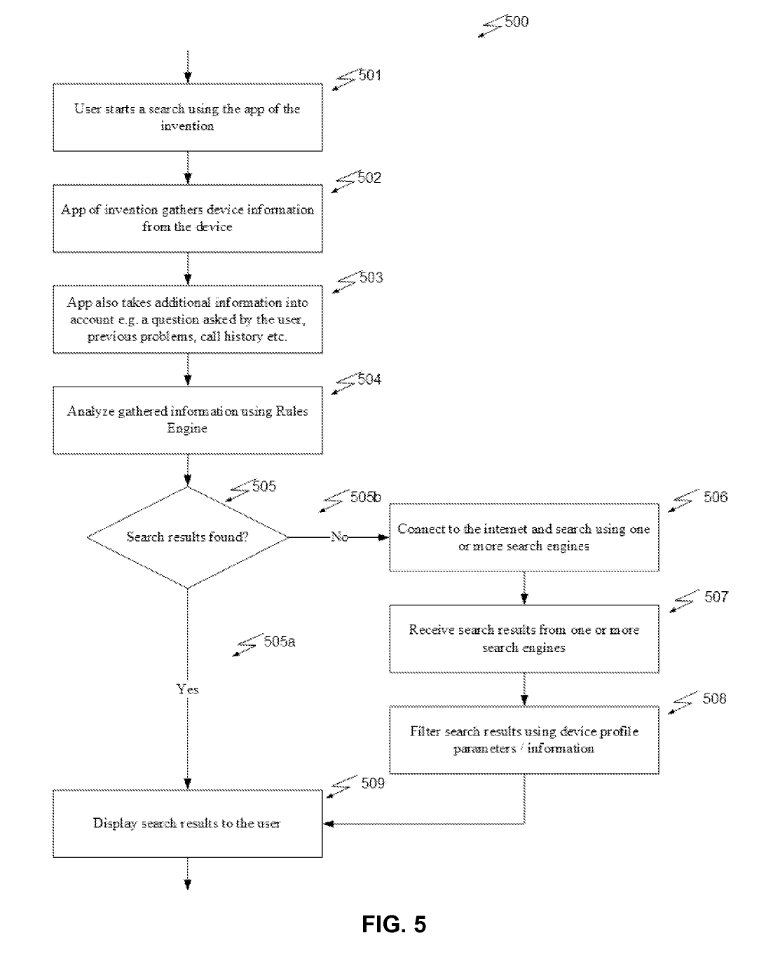

FIG. 5 shows an embodiment 500. After the user starts a search using the app 501, the app gathers device information from the device 502. In the preferred embodiment examples of device parameters that may be extracted from the device may include but are not limited to screensavers, screensaver timeouts, WiFi settings, e-mail settings, how often e-mail is checked, apps installed, types of apps installed, CPU usage, memory usage over time, error logs, length of the errors logs while also looking at the severity of the errors in each log, number of crashes, frequency of crashes, battery usage/drainage, memory usage and memory leaks, number of apps installed on the device, the mix of apps installed on the device, number of calls that the user of the device may have made to the customer care/helpdesk of the device or service provider (e.g. Smartphone service provider).

Additional information may also be taken into account e.g. a question asked by the user, previous problems, call history etc. 503.

The gathered information may be analysed using a Rules Engine 504. The analysis of the device profile parameters may be carried out using a rules engine. A rules engine is a software system that executes one or more rules in a runtime environment. A rule engine may be viewed as a sophisticated if/then statement interpreter. The if/then statements that are interpreted are called rules.

The logic for dealing with the device profiles may be coded in the form of rules. A rule consists of some number of conditions and some number of actions. Generally the rules are written in a high-level business language that relates to the domain, storing the rules in the repository. A database may be used as the preferred and exemplary embodiment to store the rules. In another embodiment the rules may be stored in a list, in a table or other method that may be suitable for so doing.

A rule can generally be represented as IF CONDITION(S) THEN RECOMMENDATION(S)/FIX(ES). It can consist of one or more conditions (the “IF”). One or more conditions can be grouped together by “and” and “or” and the order of operations can be further defined using brackets. In each condition, there could be a device attribute, a conditional operator (=, >, <, !=, exists, not exists) and then a text box in which to enter static text, numeric, date-time value or another device attribute. These conditions can then be rearranged, grouped, and joined together to form a bigger condition.

A rule may also contain a recommendation or a fix (the “THEN”). When saved, the rules may follow the Rules Lifecycle (status including but not limited to DRAFT, PENDING, VALIDATION, REJECTED, VALIDATED (Nth), ACTIVE, INACTIVE) and only active rules may be disseminated to other sources.

In one embodiment there may be a rules engine that uses rules to apply this logic. In one embodiment each rule may embody the actual, required values for the different fields e.g. SMTP Server, Gateway IP addresses, APN, Build Versions, User name, Passwords, list of malicious apps, etc. The actual values may be seeded in a rule or could be obtained from another source either on the server or on the device. In one embodiment the execution of the rules allows for the comparison of the values found on the device with the reference values. If the values are the same, i.e. the value of a filed in the device and the value of the field in the reference are equal it is concluded that no changes may be required. If the two values, i.e. the value of a field in the device and the value of the field in the reference, are NOT equal it is concluded that the device is in need of a fix and the value of the field in the device is replaced with the value of field from the reference.

It is to be understood that the rules engine is not necessarily linear when executing the rules. There may be a common starting point when executing the rules, but as the rules get executed and as information gathered from the device is analyzed, one rule may trigger another rule that may be part of another set of rules. There may also be loops, so that there are rules embedded within rules, or a rule many call another rule as part of its execution. The rule that is called from within the loop or the rule that is called as part of the execution of another rule may not fixed or static but may depend on the situation and vary as needed. Some exemplary rules engines are described in U.S. Ser. Nos. 13/968,631 and 14/256,640, both incorporated herein by reference.

The system checks if search results were found 505. If Yes 505a, search results were available from the analysis carried out by the Rules Engine, then the search results are displayed to the user 509.

If No 505b, search results were not available from the analysis carried out by the Rules Engine, then the app connects to the internet and searches using one or more search engines 506. In one embodiment the app submits the search query to search engines like Google, Yahoo, Bing or any other search engine that may have been considered useful.

Search results are received from one or more search engines 507. In one embodiment the app receives search results from Google, Yahoo, Bing and any other search engine that may have been used.

The search results are filtered using device profile parameters/information 508. In one embodiment the app filters search results using the terms, device profile parameters/information that was initially inserted into the search query. In another embodiment the app may use terms other than the ones inserted into the search query to further refine the search results. Any search results that do not contain the relevant information and thus are low in relevance to the search query are rejected while those that are highly relevant to the search query are to be used further in the inventive process.

The search results are displayed to the user 509. For example the search results may be displayed on a touchscreen of a Smartphone, or the display of a SmartTV etc. For devices that may not have their own native display e.g. a set top box, filtered search results may be displayed on a display connected to the said device; in this case a TV or a monitor.

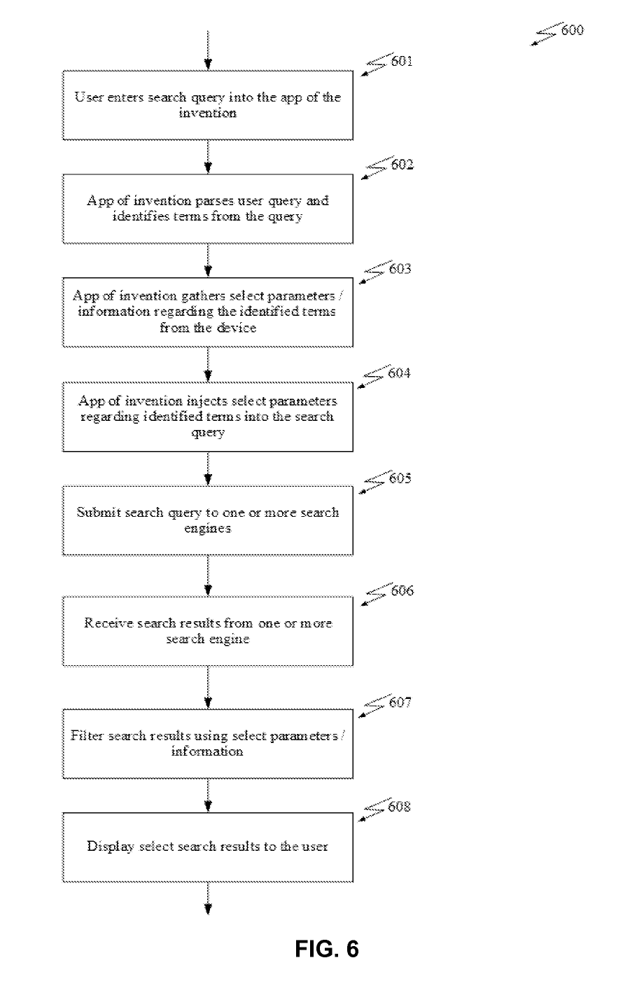

FIG. 6 shows an embodiment 600. User enters the basic search query into the app 601. For example the user types “WiFi not working” into the search query.

The app parses the user query and identifies terms from the query 602. Thus parsing the exemplary query above the term “WiFi” may be identified.

The app gathers select parameters/information regarding the identified terms from the device 603. Thus the method and system extracts only WiFi related parameters/information from the device.

The app injects select parameters regarding identified terms into the search query 604.

A search query is submitted to one or more search engines 605. In one embodiment the app submits the search query to Google, Yahoo, Bing and any other search engine that may be relevant to the search and the location of the user.

Receive search results from one or more search engines 606. In one embodiment the app receives search results from Google, Yahoo, Bing and any other search engine that may have been used.

Search results are filtered using select parameters/information 607. In one embodiment the app filters search results using the terms, device profile parameters/information that were initially inserted into the search query. In another embodiment the app may use terms other than the ones inserted into the search query to further refine the search results. Any search results that do not contain the relevant information and thus are low in relevance to the search query may be rejected while those that are highly relevant to the search query may be used further.

Select search results are displayed to the user 608. For example the search results may be displayed on a touchscreen of a Smartphone, or the display of a SmartTV etc. For devices that may not have their own native display e.g. a set top box, filtered search results may be displayed on a display that may be connected to the said device; in this case a TV or a monitor.

As a real world example a user may enter a search query “WiFi not working”. The system and method may preferably then add the device make, model, OS and firmware version to the query. Thus the query may preferably be changed to:

“WiFi not working Samsung Galaxy S4 Android 4.2.2 firmware vX.x”

Or alternatively:

“WiFi not working Samsung Galaxy S4 Android 4.2.2 firmware vX.x site:samsung.com”

Thus the search results after filtration may reveal that there is a known problem of WiFi not working on Samsung Galaxy S4 when the version of firmware is vX.x, and in order to get the WiFi to work the firmware needs to be updated.

It should be understood that although the term application (or app) has been used as an example in this disclosure, but in essence the term may also imply to any other piece of software code where the embodiments are incorporated. The software application can be implemented in a standalone configuration or in combination with other software programs and is not limited to any particular operating system or programming paradigm described here.

Several exemplary embodiments/implementations have been included in this disclosure, but the intent is to cover all such areas that may benefit from the present system and method.

The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of augmenting a search query, comprising:
receiving terms of a basic search query with respect to a user's device;
retrieving a device profile of the device, the profile having device parameters;
forming an augmented search query by concatenating at least one of the device parameters with at least one of the terms of the basic search query;
submitting the augmented search query to a search engine; and
displaying at least one result of the augmented search query.

2. The method of claim 1, wherein the terms of the basic search query are received by typing text.

3. The method of claim 1, wherein the terms of the basic search query are received by voice input.

4. The method of claim 1, wherein the receiving step utilizes a specialized app on the device.

5. The method of claim 1, wherein the device profile is freshly extracted at the time of the basic search query.

6. The method of claim 1, wherein the device profile is from a cache of a previous device profile.

7. The method of claim 1, wherein the forming step includes parsing the terms of the basic search query.

8. The method of claim 1, wherein the forming step includes adding Boolean operators, wildcards, quotes, or parentheses.

9. The method of claim 1, wherein the forming step follows a specified syntax of the search engine.

10. The method of claim 1, wherein the forming step includes dropping terms of the basic search query, or substituting the terms for industry standard terminology, or replacing terms in abbreviated form with full names.

11. The method of claim 1, wherein the forming step includes selecting a device parameter relevant to the at least one term of the basic search query.

12. The method of claim 1, wherein the step of submitting to a search engine includes searching a specialized website or forum.

13. The method of claim 1, wherein the step of submitting to a search engine includes searching the Internet.

14. The method of claim 1, wherein the displaying step includes filtering the results before displaying.

15. The method of claim 1, wherein the filtering step includes assessing the relevance of the results based on at least one device parameter.

16. The method of claim 1, wherein the results are assessed for relevance, and if the results are not sufficiently relevant, a new search is submitted with more parameters.

17. The method of claim 1, wherein if there are too few results, a new search is submitted with fewer parameters.

18. The method of claim 1, wherein the forming step includes adding a term from a previous query or problem.

19. The method of claim 1, wherein the parameters are selected by the user.

20. The method of claim 1, wherein the parameters are automatically selected.

21. The method of claim 1, wherein the at least one result is displayed on the device.

22. The method of claim 1, wherein the at least one result is displayed on a device connected to the device.

23. The method of claim 1, wherein the entire method carried out on the device.

24. The method of claim 1, wherein the basic search query is entered by a CSR.

25. The method of claim 1, wherein the at least one result is displayed on a CSR terminal.

26. A method of enhancing a device self-care session through an augmented search, comprising:
initiating a self-care session for a device with respect to a particular issue;
retrieving a device profile of the device, the profile having device parameters;
performing an initial diagnostic step, including submitting the issue and at least one of the device parameters to a rules engine;
after the initial diagnostic step, forming an augmented search query by concatenating at least one of the device parameters with at least one term describing the issue;
submitting the augmented search query to a search engine; and
displaying at least one result of the augmented search query.
